(19) United States
(12) Patent Application Publication
(10) Pub. No.: US 2007/0155907 A1
(43) Pub. Date: Jul. 5, 2007

(54) Biologically active block copolymers

(76) Inventor: Jonathon Z. Zhao, Belle Mead, NJ (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/323,760

(22) Filed: Dec. 30, 2005

(51) Int. Cl. C08F 297/02

(52) U.S. Cl. 525/242

(57) ABSTRACT

The present invention discloses a block copolymer having a hydrophobic block, a hydrophilic block, and a biologically active block. The biologically active block is directly adjacent to the hydrophilic block. Preferably, the block copolymer is prepared through reversible addition fragmentation transfer (RAFT) polymerization. The present invention also discloses a coating composition comprising the inventive block copolymer. The coating composition may be used for applying on at least a portion of one surface of an article. Moreover, the present invention discloses an article having the inventive coating composition thereon. Preferably, the article is a medical device or a component of a medical device.

### FIELD OF INVENTION

The present invention relates to a new class of block copolymers and a coating composition comprising the inventive block copolymers. The present invention also relates to an article having the inventive coating thereon.

### BACKGROUND OF INVENTION

Most medical devices are made from metals, ceramics, or polymeric materials. However, these materials are hydrophobic, non-conformal, and non-slippery, and thereby may cause thrombus formation, inflammation, or other injuries to mucous membranes during use or operation. Thus, the issue of biocompatibility is a critical concern for manufacturers of medical devices, particularly medical implants. In order to function properly and safely, medical devices are usually coated with one or more layers of biocompatible materials. The coatings on these medical devices may, in some instances, be used to deliver therapeutic and pharmaceutical agents.

Since medical devices, particularly implantable medical devices, are intended for prolonged use and directly interface with body tissues, body fluids, electrolytes, proteins, enzymes, lipids, and other biological molecules, the coating materials for medical devices must meet stringent biological and physical requirements. These requirements, as a minimum, include the following: (1) the coatings must be hydrophilic and lubricous when in contact with body tissue, and thereby increase patient comfort during operation and enhance the maneuverability of the medical device; (2) the coatings must be flexible and elastic, so they conform to the biological structure without inducing detrimental stress; (3) the coatings must be hemocompatible, and thereby reduce or avoid formation of thrombus or emboli; (4) the coatings must be chemically inert to body tissue and body fluids; and (5) the coatings must be mechanically durable and not crack when formed on medical devices. If the coatings are impregnated with pharmaceutical or therapeutic agents, it is typically required that the coatings and the formation thereof are compatible with the pharmaceutical or therapeutic agents. If the coatings are used as coatings and the underlying basecoats are impregnated with pharmaceutical or therapeutic agents, it is further required that the coating and the formation thereof must be compatible with the basecoat and the pharmaceutical or therapeutic agents impregnated therein; and the coating must allow the pharmaceutical or therapeutic agents to permeate therethrough. It is also desirable that the coating functions as a physical barrier, a chemical barrier, or a combination thereof to control the elution of the pharmaceutical or therapeutic agents in the underlying basecoat.

In order to combine the desired properties of different polymeric materials, the conventional coating composition for commercial drug eluting stents used a polymer blend, i.e., physical mixture, of poly ethylene-vinyl acetate (EVAc) and poly butyl methacrylate (BMA). However, one disadvantage of this conventional coating is the phase separation of the polymer blend, which can be detrimental to the performance of the coating and the stability of drugs impregnated therein.

Another coating composition of the prior art comprises a supporting polymer and a hydrophilic polymer, wherein the supporting polymer contains functional moieties capable of undergoing crosslinking reactions and the hydrophilic polymer is associated with the supporting polymer (see, for example, U.S. Pat. No. 6,238,799). However, the preparation of this prior art coating composition employs chemical crosslinking reactions and a high temperature curing process, which are not compatible with a drug-containing coating.

The prior art also uses a coating composition formed by the gas phase or plasma polymerization of a gas comprising monomers of polyethylene glycol vinyl ether compounds (see, for example, U.S. Patent Application Publication 2003/0113477). However, the polymer prepared through the plasma process has poorly defined molecular weight and a large polydispersity. The plasma laid polymers of low molecular weight have limited mechanical durability. Further, plasma treatment can penetrate through the underlying basecoat and damage the drug content therein. Another problem with this prior art approach is that the free radicals or other high energy species generated in the plasma process may persist in the coating and cause drug content loss in the basecoat over time.

To decrease thrombosis caused by the use of medical devices, the prior art also modifies the coatings o f medical devices via conjugating, i.e., covalently bonding, an antithrombotic agent (e.g., heparin) to the coatings (see, for example, U.S. Pat. No. 4,973,493 and www.surmodics.com). Although this approach may produce a coating with excellent antithrombotic property, the prior art conjugation methods employ complex preparation processes and produce various by-products that may cause degradation of the antithromnbotic agent in the coating.

Thus, there remains a need for a polymeric material and a coating composition that can satisfy the stringent requirements, as described above, for applying on at least one surface of a medical device and can be prepared through a process that is compatible with the pharmaceutical or therapeutic agents physically or chemically impregnated in the coatings.

### SUMMARY OF THE INVENTION

Accordingly, the present invention provides a block copolymer comprising a hydrophobic block, a hydrophulic block, and a biologically active block, wherein the biologically active block is directly adjacent to the hydrophilic block.

In one embodiment of the present invention, the block copolymer comprises the following structure: 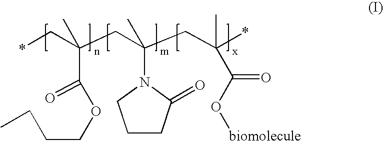
wherein x, n, and m are the same or different, and are independently an integer of 10 to 2500; and biomolecule is selected from the group consisting of anti-thrombogenic agents, immuno-suppressants, anti-neoplastic agents, anti-inflammatory agents, angiogenesis inhibitors, protein kinase inhibitors, proteins, peptides, DNA, RNA, siRNA, ribozymes, polysaccharides, oligosaccharides, and lipids. Preferably, biomolecule is heparin.

The present invention also provides a block copolymer comprises the following structure: 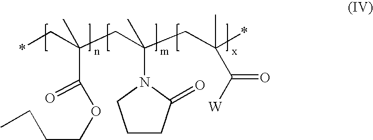
wherein x, n, and m, are the same or different, and are independently an integer of 10 to 2500; and W is an active intermediate. Preferably, W is N-hydroxysuccinimidyl.

The present invention also provides a coating composition for applying on at least a portion of one surface of an article, said coating composition comprising a block copolymer having a hydrophobic block, a hydrophilic block, and a biologically active block, wherein the biologically active block is directly adjacent to the hydrophilic block.

In another aspect, the present invention provides an article having a coating thereon, said coating comprising a block copolymer having a hydrophobic block, a hydrophilic block, and a biologically active block, wherein the biologically active block is directly adjacent to the hydrophilic block. Preferably, the article is a medical device or a component of a medical device.

### DETAILED DESCRIPTION OF THE INVENTION

The present invention provides a block copolymer comprising a hydrophobic block, a hydrophilic block, and a biologically active block. The biologically active block is directly adjacent to the hydrophilic block. By “block copolymer”, it is meant a heteropolymer comprising blocks of different polymerized monomers. Preferably, the inventive block copolymer is linear. That is, it is preferred that the inventive block copolymer has a shape of a straight chain.

The hydrophobic block of the inventive block copolymer comprises polymerized monomer units of one or more alkyl methacrylate or alkyl acrylate. By “hydrophobic”, it is meant lacking affinity for water and tending to dissolve in or mix with organic solvents or lipids. During polymerization, the vinyl moieties of the monomer units of one or more alkyl methacrylate or alkyl acrylate form a linear backbone, while the moieties other than the vinyl moieties of the monomer units of one or more alkyl methacrylate or alkyl acrylate constitute pendant groups covalently attached to the linear backbone. By “alkyl methacrylate”, it is meant a methacrylate derivative wherein the oxygen atom attached to the carbon atom of the carbonyl group is substituted with an alkyl group. By “alkyl acrylate”, it is meant an acrylate derivative wherein the oxygen atom attached to the carbon atom of the carbonyl group is substituted with an alkyl group. Examples of alkyl methacrylate suitable for the present invention include, but are not limited to: methyl methacrylate, ethyl methacrylate, propyl methacrylate, butyl methacrylate, pentyl methacrylate, hexyl methacrylate, heptyl methacrylate, octyl methacrylate, nonyl methacrylate, and dodecyl methacrylate. Examples of alkyl acrylate suitable for the present invention include, but are not limited to: methyl acrylate, ethyl acrylate, propyl acrylate, butyl acrylate, pentyl acrylate, hexyl acrylate, heptyl acrylate, octyl acrylate, nonyl acrylate, and dodecyl acrylate.

The hydrophilic block of the inventive block copolymer comprises polymerized monomer units selected from the group consisting of acrylamide, N, N-dimethyl acrylamide, N-isopropyl acrylamide, acrylic acid, styrene sulfonic acid, vinyl alcohol, ethylene glycol, and N-vinyl pyrrolidone. By “hydrophilic” it is meant having a strong affinity for water and tending to dissolve in, mix with, or swell in water or aqueous medium. During polymerization, the vinyl moieties of the monomer units selected from the group described above form a linear backbone, while the moieties other than the vinyl moieties of the monomer units selected from the group described above constitute pendant groups covalently attached to the linear backbone.

The biologically active block of the inventive block copolymer comprises a linear backbone derived from vinyl moieties and pedant biologically active molecules. By “linear backbone derived from vinyl moieties”, it is meant the backbone of the biologically active block is a straight chain and is formed by polymerization of vinyl groups. The pedant biologically active molecules are covalently attached to the linear backbone derived from vinyl moieties. Preferably, the biologically active block is directly adjacent to the hydrophilic block and is not directly adjacent to the hydrophobic block. The “pendant biologically active molecule” as used herein denotes a compound or substance having an effect on or eliciting a response from living tissue. The pendant biologically active molecules suitable for the present invention include, for example, any drugs, agents, compounds and/or combination thereof that have therapeutic effects for treating or preventing a disease or a biological organism's reaction to the introduction of the medical device to the organism. Preferred pendant biologically active molecules include, but are not limited to: anti-thrombogenic agents, immuno-suppressants, anti-neoplastic agents, anti-inflammatory agents, angiogenesis inhibitors, protein kinase inhibitors, and other agents which may cure, reduce, or prevent restenosis in a mammal. Preferred pendant biologically active molecules also include proteins, peptides, DNA, RNA, siRNA, ribozymes, polysaccharides, oligosaccharides, and lipids. Examples of the pendant biologically active molecules of the present invention include, but are not limited to: heparin, albumin, streptokinase, tissue plasminogin activator (TPA), urokinase, rapamycin, paclitaxel, pimecrolimus, proteins, peptides, DNA, RNA, siRNA, ribozymes, polysaccharides, oligosaccharides, lipids, and their analogs and derivatives. Preferably, the heparin used in the present invention is a low molecular weight heparin. The biologically active block imparts biological activity to the inventive block copolymer. Since a wide range of pendant biologically active molecules can be used for the biologically active block, the biological activity of the inventive block copolymer may be adjusted accordingly.

In one embodiment of the present invention, the inventive block copolymer comprises the following structure: 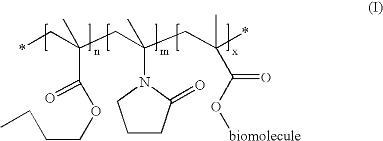
wherein x, n, and m are the same or different, and are independently an integer of 10 to 2500; and biomolecule is selected from the group consisting of anti-thrombogenic agents, immuno-suppressants, anti-neoplastic agents, anti-inflammatory agents, angiogenesis inhibitors, protein kinase inhibitors, proteins, peptides, DNA, RNA, siRNA, ribozymes, polysaccharides, oligosaccharides, and lipids.

In another embodiment of the present invention, the inventive block copolymer comprises the following structure: 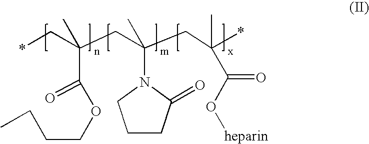
wherein x, n, and m are the same or different, and are independently an integer of 10 to 2500. Preferably, the heparin used in the present invention is a low molecular weight heparin.

The present invention also provides a block copolymer comprises the following structure: 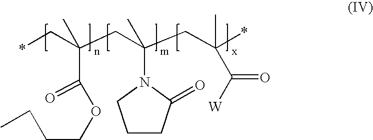
wherein x, n, and m, are the same or different, and are independently an integer of 10 to 2500; and W is an active intermediate. The term “an active intermediate” as used herein denotes a chemical moiety that can be a good leaving group. The block copolymer of formula (IV) may be a precursor of the block copolymer of formula (I). Specifically, when the block copolymer of formula (IV) is exposed to a biomolecule selected from anti-thrombogenic agents, immuno-suppressants, anti-neoplastic agents, anti-inflammatory agents, angiogenesis inhibitors, protein kinase inhibitors, proteins, peptides, DNA, RNA, siRNA, ribozymes, polysaccharides, oligosaccharides, and lipids, the biomolecule will replace W under ambient conditions forming the block copolymer of formula (I). Therefore, W can be used to introduce a biomolecule through mild conjugation reactions.

Preferably, W in formula (IV) is N-hydroxysuccinimidyl. That is, the block copolymer of formula (IV) has the following structure: 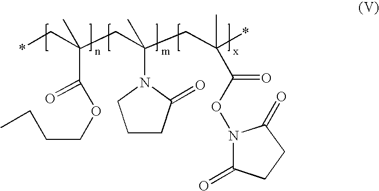
wherein x, n, and m, are the same or different, and are independently an integer of 10 to 2500.

The inventive block copolymer may be prepared through living polymerization methods. More preferably, the inventive block copolymer is prepared through reversible addition fragmentation transfer (RAFT) polymerization. Many conventional polymerization methods require chemical crosslinking reactions, high temperature curing processes, and/or plasma treatments, which not only have very limited control over the polymer molecular weight distribution, but also cause damages to the therapeutic agent impregnated in the coating and the drug-content in the underlying basecoat. Unlike those conventional polymerization methods, RAFT polymerization allows precise control of the molecular weight and molar ratio of each segment of a copolymer at ambient temperature, thereby providing a copolymer with predetermined molecular weight and narrow polydispersity, i.e., narrow molecular weight distribution. Thus, the structure and the molecular weight of the inventive block copolymer may be precisely tuned through employment of RAFT polymerization.

Accordingly, the properties of the inventive block copolymer may be tuned via adjusting the structure and/or the molar ratios of the hydrophobic block, the hydrophilic block, and the biologically active block. In other words, the structure and/or the molar ratios of the hydrophobic block, the hydrophilic block, and the biologically active block may be adjusted according to the desired properties of the inventive block copolymer. For example, the hydrophilicity or hydrophobicity of the inventive block copolymer may be adjusted through the use of hydrophilic block and/or hydrophobic block having different repeating monomer units, and/or through controlling the molar ratio between the hydrophobic block and the hydrophilic block. Furthermore, the hydrophobic block, the hydrophilic. block, and the biologically active block need to be in a molar ratio that ensures desired mechanical strength of the inventive block copolymer while providing a hydrophilic environment for retaining the optimal activity of the biologically active block. Preferably, the copolymer has the hydrophobic block, the hydrophilic block, and the biologically active block in a mole ratio of 1:1:1.

In one embodiment of the present invention, the inventive block copolymer of formula (II) is synthesized through a route illustrated in Scheme 1. 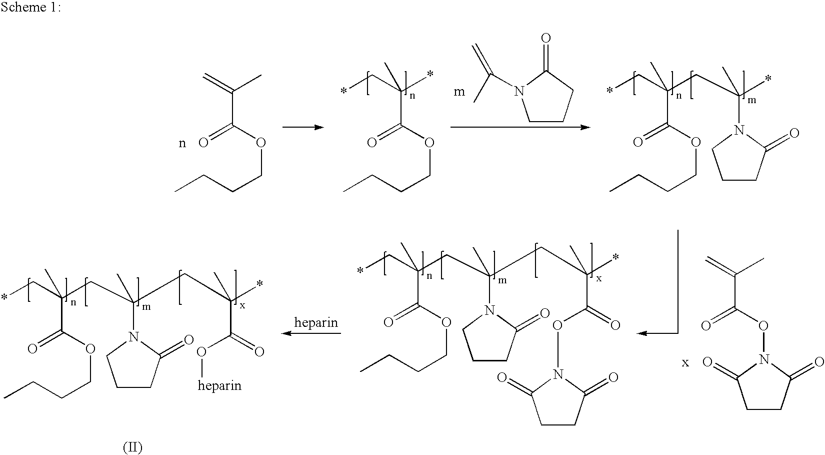
wherein x, n, and m are the same or different, and are independently an integer of 10 to 2500. RAFT polymerization has been reported in recent literatures, and one skilled in the art would be able to readily ascertain details of RAFT reaction conditions (see, for example, Shi, Peng-Jie; et al. European Polymer Journal, 2004, 40, 1283-1290).

Various functional blocks can be added to the inventive block copolymer via employing RAFT polymerization. Thus, the properties of the inventive block copolymer may be tuned accordingly. In one embodiment of the present invention, the inventive block copolymer may further comprise a photoactive block. It is preferred that the photoactive block is directly adjacent to the hydrophobic block. The photoactive block comprises a linear backbone derived from vinyl moieties and pedant photoreactive. molecules. By “linear backbone derived from vinyl moieties”, it is meant the backbone of the biologically active block is a straight chain and is formed by polymerization of vinyl groups. The pedant photoreactive molecules are covalently attached to the linear backbone derived from vinyl moieties. By “pendant photoreactive molecules”, it is meant molecules that absorb ultraviolet light of certain wavelength band and consequently initiate a crosslinking polymerization process. The pendant photoreactive molecules may be any photoreactive molecules compatible with the hydrophobic block, the hydrophilic block, and the biologically active block of the inventive block copolymer. Examples of pendant photoreactive molecules suitable for the present invention include, but are not limited to: benzophenone, azide, thioxanthone, and derivatives thereof.

In one embodiment of the present invention, the inventive block copolymer comprises the following structure: 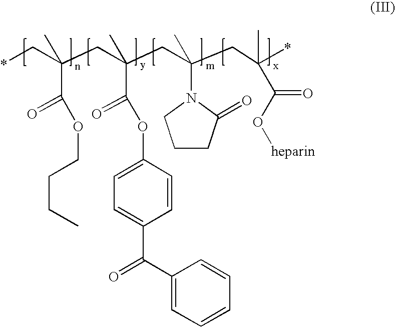
wherein x,, n, and m are the same or different, and are independently an integer of 10 to 2500, and y is an integer of 1 to 10.

In one embodiment of the present invention, the inventive block copolymer of formula (III) is synthesized through a route illustrated Scheme 2. 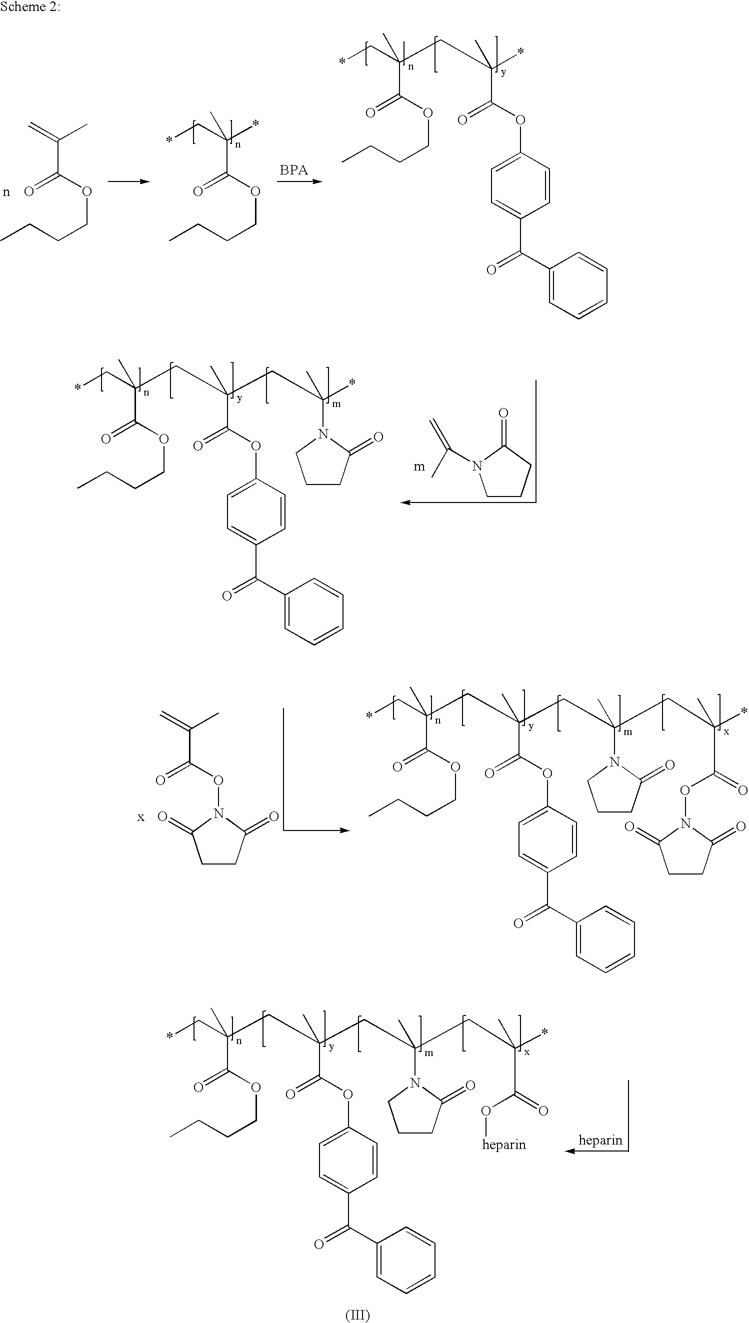
wherein x, n, and m are the same or different, and are independently an integer of 10 to 2500, and y is an integer of l to 10; and BPA is benzophenone methacrylate, which has the following structure:

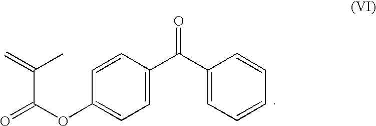

It is preferable that the inventive block copolymer has a tunable polymer molecular weight ranging from about 5,000 to about 500,000 Daltons to enable the formation of a coating with desirable mechanical durability and adequate adhesiveness. Since the mechanical durability of a coating improves upon increasing polymer molecular weight, it is especially preferable that the inventive block copolymer has a high polymer molecular weight of 10,000 to 500,000 Daltons for use in coatings for certain medical devices (e.g., stents) which require expansion and deployment in vivo.

The present invention also provides a coating composition for applying on at least a portion of one surface of an article. The coating composition comprises a block copolymer having a hydrophobic block, a hydrophilic block, and a biologically active block, wherein the biologically active block is directly adjacent to the hydrophilic block. Preferably, the block copolymer is linear. The hydrophobic block of the block copolymer comprises polymerized monomer units of one or more alkyl methacrylate or alkyl acrylate. Examples of alkyl methacrylate suitable for the present invention include, but are not limited to: methyl methacrylate, ethyl methacrylate, propyl methacrylate, butyl methacrylate, pentyl methacrylate, hexyl methacrylate, heptyl methacrylate, octyl methacrylate, nonyl methacrylate, and dodecyl methacrylate. Examples of alkyl acrylate suitable for the present invention include, but are not limited to: methyl acrylate, ethyl acrylate, propyl acrylate, butyl acrylate, pentyl acrylate, hexyl acrylate, heptyl acrylate, octyl acrylate, nonyl acrylate, and dodecyl acrylate. The hydrophilic block of the block copolymer comprises polymerized monomer units selected from the group consisting of acrylamide, N, N-dimethyl acrylamide, N-isopropyl acrylamide, acrylic acid, styrene sulfonic acid, vinyl alcohol, ethylene glycol, and N-vinyl pyrrolidone. The biologically active block of the block copolymer comprises a linear backbone derived from vinyl moieties and pedant biologically active molecules. The pedant biologically active molecules are covalently attached to the linear backbone derived from vinyl moieties. Preferred pendant biologically active molecules include, but are not limited to: anti-thrombogenic agents, immuno-suppressants, anti-neoplastic agents, anti-inflammatory agents, angiogenesis inhibitors, protein kinase inhibitors, and other agents which may cure, reduce, or prevent restenosis in a mammal. Preferred pendant biologically active molecules also include proteins, peptides, DNA, RNA, siRNA, ribozymes, polysaccharides, oligosaccharides, and lipids. Examples of the pendant biologically active molecules of the present invention include, but are not limited to: heparin, albumin, streptokinase, tissue plasminogin activator (TPA), urokinase, rapamycin, paclitaxel, pimecrolimus, proteins, peptides, DNA, RNA, siRNA, ribozymes, polysaccharides, oligosaccharides, lipids, and their analogs and derivatives. Preferably, the heparin used in the present invention is a low molecular weight heparin.

The block copolymer may further comprise a photoactive block. It is preferred that the photoactive block is directly adjacent to the hydrophobic block. The photoactive block comprises a linear backbone derived from vinyl moieties and pedant photoreactive molecules. The pedant photoreactive molecules are covalently attached to the linear backbone derived from vinyl moieties. The pendant photoreactive molecules may be any photoreactive molecules compatible with the hydrophobic block, the hydrophilic block, and the biologically active block of the inventive block copolymer. Examples of pendant photoreactive molecules suitable for the present invention include, but are not limited to: benzophenone, azide, thioxanthone, and derivatives thereof. The pendant photoactive block allows photo crosslinking of the inventive block copolymer, thereby enhancing the durability of the inventive coating composition.

The inventive coating composition may additionally include co-solvents and/or other additives to facilitate high quality film formation, such as plasticizers, antifoaming agents, anticrater agents, and coalescing solvents. Other suitable additives to the inventive coating composition include, but are not limited to: bioactive agents, antimicrobial agents, antithrombogenic agents, antibiotics, pigments, radiopacifiers and ion conductors. Details concerning the selection and amounts of such ingredients are known to those skilled in the art.

The inventive coating composition may be applied on at least a portion of one surface of an article. In some embodiments, the inventive coating is applied to all exposed surfaces of an article. The thickness of the inventive coating composition may vary depending on the process used in forming the coating as well as the intended use of the article. Typically, and for a medical device, the inventive coating is applied to a thickness from about 1 nanometer to about 10 micrometer, with a thickness from about 10 nanometer to about 10 micrometer being more typical. The inventive block copolymer is soluble in common organic solvents, such as tetrahydrofuran (THF), acetone, chloroform, dichloromethane, acetonitrile, dimethylformide (DMF), and mixtures thereof. Since organic solvents are widely used to handle polymeric material, the inventive coating composition may be applied on at least one surface of an article through various coating processes (e.g., spray coating process).

When applied on at least one surface of an article, the linear backbone and the hydrophobic block provide the inventive block copolymer with improved mechanical durability and enhanced adhesion to the underlying surface, while the hydrophilic block and the biologically active block impart lubricity and hemocompatibility. Furthermore, the hydrophobic block and the hydrophilic block are adjustable to various lengths to obtain the desirable elasticity of the inventive block copolymer. Moreover, the hydrophilic block can hydrate and swell under physiological conditions and provide a desirable environment for the biologically active block to retain the biological activity.

The inventive coating composition may also be applied to control the elution of a therapeutic dosage of a pharmaceutical agent from a medical device base coating, for example, a stent base coating. The basecoat generally comprises a matrix of one or more drugs, agents, and/or compounds and a biocompatible material such as a polymer. The control over elution results from either a physical barrier, or a chemical barrier, or a combination thereof. The elution is controlled by varying the thickness of the coating, thereby changing the diffusion path length for the drugs, agents, and/or compounds to diffuse out of the basecoat matrix. Essentially, the drugs, agents and/or compounds in the basecoat matrix diffuse through the interstitial spaces in the coating. Accordingly, the thicker the coating, the longer the diffusion path, and conversely, the thinner the coating, the shorter the diffusion path. The effectiveness of the inventive coating composition as a regulator for drug elution from the basecoat may be maximized via tuning the relative molar ratio of the various blocks in the block copolymer for the optimal hydrophobicity of the block copolymer. It is important to note that both the basecoat and the coating thickness may be limited by the desired overall profile of the article on which they are applied.

The present invention also provides an article having a coating thereon. The coating comprises a block copolymer having a hydrophobic block, a hydrophilic block, and a biologically active block. The biologically active block is directly adjacent to the hydrophilic block. The at least a portion of one surface of the article may be a surface of a polymeric coat, a plastic substance, ceramic, steel, or other alloy metals. Various functional blocks, such as, for example, a photoactive block, can be added to the inventive block copolymer to impart desirable properties to the inventive block copolymer and the inventive coating.

The article that may be coated with the inventive coating composition may be in any shape, and is preferably a medical device or a component of a medical device. More preferably, the medical device or the component of a medical device is implantable. The term “medical device” as used herein denotes a physical item used in medical treatment, which includes both external medical devices and implantable medical devices. The medical devices that may be coated with the inventive coating composition include, but are not limited to: catheters, guidewires, drug eluting stents, cochlear implants, retinal implants, gastric bands, neurostimulation devices, muscular stimulation devices, implantable drug delivery devices, intraocular devices, and various other medical devices.

The present coating composition may be applied to the surface of an article using conventional coating techniques, such as, for example, spray coating, ultrasonic coating, dip coating, and the like. In a dip coating process, the article is immersed in a bath containing the coating composition and then removed. A dwelling time ranging from about 1 minute to about 2 hours may be used depending of the material of construction, complexity of the device, and the desired coating thickness. Next, the article coated with the coating composition may be allowed to dry to provide a dry coating. Drying may be accomplished merely by standing at ambient conditions or may be accelerated by heating at mild temperatures, such as about 30° C. to about 65° C.

While the present invention has been particularly shown and described with respect to preferred embodiments thereof, it will be understood by those skilled in the art that the foregoing and other changes in forms and details may be made without departing from the spirit and scope of the invention. It is therefore intended that the present invention not be limited to the exact forms and details described and illustrated but fall within the scope of the appended claims.

Having thus described the invention in detail, what is claimed as new and is desired to be secured by the Letters Patent is:

1. A block copolymer comprising a hydrophobic block, a hydrophilic block, and a biologically active block, wherein the biologically active block is directly adjacent to the hydrophilic block.

2. The block copolymer of claim 1, wherein the hydrophobic block comprises polymerized monomer units of one or more alkyl methacrylate or alkyl acrylate.

3. The block copolymer of claim 2, wherein the polymerized monomer units of one or more alkyl methacrylate are selected from the group consisting of methyl methacrylate, ethyl methacrylate, propyl methacrylate, butyl methacrylate, pentyl methacrylate, hexyl methacrylate, heptyl methacrylate, octyl methacrylate, nonyl methacrylate, and dodecyl methacrylate.

4. The block copolymer of claim 2, wherein the polymerized monomer units of one or more alkyl acrylate are selected from the group consisting of methyl acrylate, ethyl acrylate, propyl acrylate, butyl acrylate, pentyl acrylate, hexyl acrylate, heptyl acrylate, octyl acrylate, nonyl acrylate, and dodecyl acrylate.

5. The block copolymer of claim 1, wherein the hydrophilic block comprises polymerized monomer units selected from the group consisting of acrylamide, N, N-dimethyl acrylamide, N-isopropyl acrylamide, acrylic acid, styrene sulfonic acid, vinyl alcohol, ethylene glycol, and N-vinyl pyrrolidone.

6. The block copolymer of claim 1, wherein the biologically active block comprises a linear backbone derived from vinyl moieties and pedant biologically active molecules, the pedant biologically active molecules are covalently attached to the linear backbone derived from vinyl moieties.

7. The block copolymer of claim 6, wherein the pendant biologically active molecules are selected from the group consisting of anti-thrombogenic agents, immuno-suppressants, anti-neoplastic agents, anti-inflammatory agents, angiogenesis inhibitors, protein kinase inhibitors, proteins, peptides, DNA, RNA, siRNA, ribozymes, polysaccharides, oligosaccharides, and lipids.

8. The block copolymer of claim 7, wherein the pendant biologically active molecules are selected from the group consisting of heparin, proteins, peptides, DNA, RNA, siRNA, ribozymes, polysaccharides, oligosaccharides, and lipids.

9. The block copolymer of claim 1 comprises the following structure: 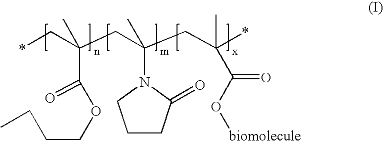
wherein x, n, and m are the same or different, and are independently an integer of 10 to 2500; and biomolecule is selected from the group consisting of anti-thrombogenic agents, immuno-suppressants, anti-neoplastic agents, anti-inflammatory agents, angiogenesis inhibitors, protein kinase inhibitors, proteins, peptides, DNA, RNA, siRNA, ribozymes, polysaccharides, oligosaccharides, and lipids.

10. The block copolymer of claim 9 comprises the following structure: 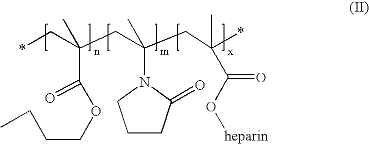
wherein x, n, and m are the same or different, and are independently an integer of 10 to 2500.

11. The block copolymer of claim 1 further comprises a photoactive block, said photoactive block comprising a linear backbone derived from vinyl moieties and pedant photoreactive molecules, the pedant photoreactive molecules are covalently attached to the linear backbone derived from vinyl moieties.

12. The block copolymer of claim 11, wherein the pendant photoreactive molecules are benzophenone, azide, thioxanthone, or derivatives thereof.

13. The block copolymer of claim 12 comprises the following structure: 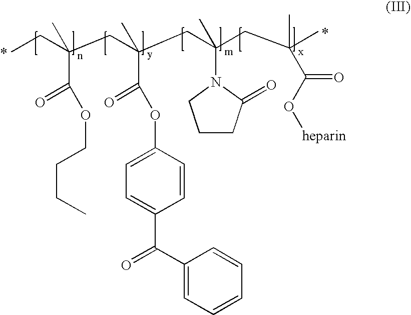
wherein x, n, and m, are the same or different, and are independently an integer of 10 to 2500; and y is an integer of 1 to 10

14. The block copolymer of claim 1 has a tunable molecular weight ranging from about 5,000 to about 500,000 Daltons.

15. A block copolymer comprising the following structure: 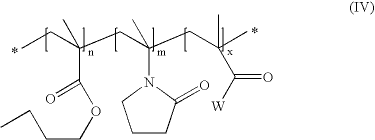
wherein x, n, and m, are the same or different, and are independently an integer of 10 to 2500; and W is an active intermediate.

16. The block copolymer of claim 15 comprising the following structure: 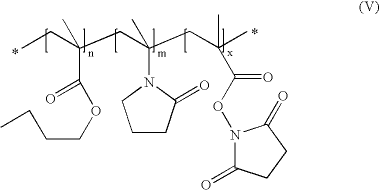
wherein x, n, and m, are the same or different, and are independently an integer of 10 to 2500.

17. A coating composition for applying on at least a portion of one surface of an article, said coating composition comprising a block copolymer having a hydrophobic block, a hydrophilic block, and a biologically active block, wherein the biologically active block is directly adjacent to the hydrophilic block.

18. The coating composition of claim 17 has a thickness of about 1 nanometer to about 10 micrometer.

19. An article having a coating thereon, said coating comprising a block copolymer having a hydrophobic block, a hydrophilic block, and a biologically active block, wherein the biologically active block is directly adjacent to the hydrophilic block.

20. The article of claim 19, wherein the hydrophobic block comprises polymerized monomer units of one or more alkyl methacrylate or alkyl acrylate.

21. The article of claim 20, wherein the polymerized monomer units of one or more alkyl methacrylate are selected from the group consisting of methyl methacrylate, ethyl methacrylate, propyl methacrylate, butyl methacrylate, pentyl methacrylate, hexyl methacrylate, heptyl methacrylate, octyl methacrylate, nonyl methacrylate, and dodecyl methacrylate.

22. The article of claim 20, wherein the polymerized monomer units of one or more alkyl acrylate are selected from the group consisting of methyl acrylate, ethyl acrylate, propyl acrylate, butyl acrylate, pentyl acrylate, hexyl acrylate, heptyl acrylate, octyl acrylate, nonyl acrylate, and dodecyl acrylate.

23. The article of claim 19, wherein the hydrophilic block comprises polymerized monomer units selected from the group consisting of acrylamide, N, N-dimethyl acrylamide, N-isopropyl acrylamide, acrylic acid, styrene sulfonic acid, vinyl alcohol, ethylene glycol, and N-vinyl pyrrolidone.

24. The article of claim 19, wherein the biologically active block comprises a linear backbone derived from vinyl moieties and pedant biologically active molecules, the pedant biologically active molecules are covalently attached to the linear backbone derived from vinyl moieties.

25. The article of claim 24, wherein the pendant biologically active molecules are selected from the group consisting of anti-thrombogenic agents, immuno-suppressants, anti-neoplastic agents, anti-inflammatory agents, angiogenesis inhibitors, protein kinase inhibitors, proteins, peptides, DNA, RNA, siRNA, ribozymes, polysaccharides, oligosaccharides, and lipids.

26. The article of claim 25, wherein the pendant biologically active molecules are selected from the group consisting of heparin, proteins, peptides, DNA, RNA, siRNA, ribozymes, polysaccharides, oligosaccharides, and lipids.

27. The article of claim 19, wherein the block copolymer further comprises a photoactive block, said photoactive block comprising a linear backbone derived from vinyl moieties and pedant photoreactive molecules, the pedant photoreactive molecules are covalently attached to the linear backbone derived from vinyl moieties.

28. The article of claim 27, wherein the pendant photoreactive molecules are benzophenone, azide, thioxanthone, or derivatives thereof.

29. The article of claim 19, wherein the block copolymer has a tunable molecular weight ranging from about 5,000 to about 500,000 Daltons.

30. The article of claim 19, wherein the coating has a thickness of about 1 nanometer to about 10 micrometer.

31. The article of claim 19 is a medical device or a component of a medical device.
